(19) United States
(12) Patent Application Publication
(10) Pub. No.: US 2014/0174162 A1
(43) Pub. Date: Jun. 26, 2014

(54) IGNITOR PLUG ISOLATION CHAMBER (IPIC) FOR A GAS TURBINE ENGINE

(71) Applicant: UNITED TECHNOLOGIES CORPORATION, Hartford, CT (US)

(72) Inventors: Bobby J. McLarty, Jupiter, FL (US); James R. Kennedy, Orange, CT (US); Thomas W. Cashel, III, Hartford, CT (US)

(73) Assignee: United Technologies Corporation, Hartford, CT (US)

(21) Appl. No.: 13/725,189

(22) Filed: Dec. 21, 2012

(51) Int. Cl. G01M 15/14

(52) U.S. Cl. CPC G01M 15/14
USPC 73/112.01

(57) ABSTRACT

An Ignitor Plug Isolation Chamber (IPIC) includes a first end cap mountable to a cylinder, the first end cap includes an igniter aperture to receive an ignitor plug. A second end cap mountable to the cylinder, the second end cap includes a ground aperture. The ground connection mounted to the ground aperture.

### BACKGROUND

The present disclosure relates to a gas turbine engine and, more particularly, to an ignitor plug isolation chamber (IPIC) for test operations of the gas turbine engine.

Gas turbine engines, such as Industrial Gas Turbines utilized in power production, mechanical drives as well as aero engines in commercial and military aircraft, include a compressor section to pressurize airflow, a combustor section to burn a hydrocarbon fuel in the presence of the pressurized air, and a turbine section to extract energy from the resultant combustion gases.

Oftentimes, tests are performed on installed engines that utilize special instrumentation to monitor, for example, combustor pressure through an ignitor port on the engine. Typically, an ignitor plug that would otherwise be installed in the instrumented port is permitted to fire outside of the engine, however, such testing may be complicated by disposition of the removal of the ignitor plug exposes it to an environment that is classified as Class 1 Division 2 (Zone 2) under National Electric Code (NEC), or ATEX Category 3G.

### SUMMARY

An Ignitor Plug Isolation Chamber (IPIC) according to one disclosed non-limiting embodiment of the present disclosure includes a cylinder, a first end cap mountable to said cylinder, said first end cap includes an igniter aperture to receive an ignitor plug, a second end cap mountable to said cylinder, said second end cap includes a ground aperture, and a ground connection mounted to said ground aperture.

In a further embodiment of the foregoing embodiment, the cylinder is approximately six (6) inches (15 cm) long.

In a further embodiment of any of the foregoing embodiments, the cylinder is manufactured of a standard schedule 40 (ASTM A106 Grade B Carbon Steel) pipe nipple.

In a further embodiment of any of the foregoing embodiments, the first end cap and said second end cap are each 1.5 inch (38 mm) caps manufactured of schedule 40 (ASTM A106 Grade B Carbon Steel).

In a further embodiment of any of the foregoing embodiments, the first end cap and said second end cap are threaded to said cylinder.

A method of testing a gas turbine engine according to another disclosed non-limiting embodiment of the present disclosure includes removing an igniter plug from a port in a gas turbine engine, threading an instrument into the port of the gas turbine engine, and threading the igniter plug removed from the port of the gas turbine engine into an Ignitor Plug Isolation Chamber (IPIC).

In a further embodiment of the foregoing embodiment, the method includes connecting a grounding cable to the IPIC.

In a further embodiment of any of the foregoing embodiments, the method includes threading the igniter plug removed from the port of the gas turbine engine into an end cap of the IPIC.

In a further embodiment of any of the foregoing embodiments, the method includes attaching the IPIC to a structure with cable ties.

In a further embodiment of any of the foregoing embodiments, the method includes providing an air-tight volume within the IPIC.

### BRIEF DESCRIPTION OF THE DRAWINGS

Various features will become apparent to those skilled in the art from the following detailed description of the disclosed non-limiting embodiment. The drawings that accompany the detailed description can be briefly described as follows:

FIG. 1 is a schematic partial sectional view of an Industrial Gas Turbine;

FIG. 2 is a schematic view of an aircraft within a testing enclosure;

FIG. 3 is a schematic view of a gas turbine engine and an ignition system therefore;

FIG. 4 is a side view of an Ignitor Plug Isolation Chamber (IPIC);

FIG. 5 is an end view of an ignitor end cap of the Ignitor Plug Isolation Chamber (IPIC);

FIG. 6 is an end view of a grounding end cap of the Ignitor Plug Isolation Chamber (IPIC);

FIG. 7 is a perspective view of the grounding end cap of the Ignitor Plug Isolation Chamber (IPIC); and

FIG. 8 is a perspective view of the Ignitor Plug Isolation Chamber (IPIC) mounted to a gas turbine engine support arm within an enclosure.

### DETAILED DESCRIPTION

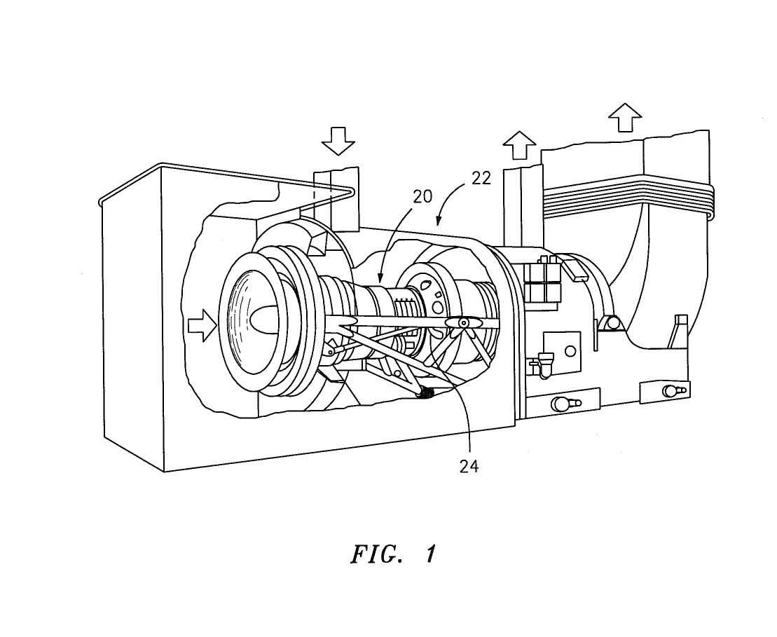

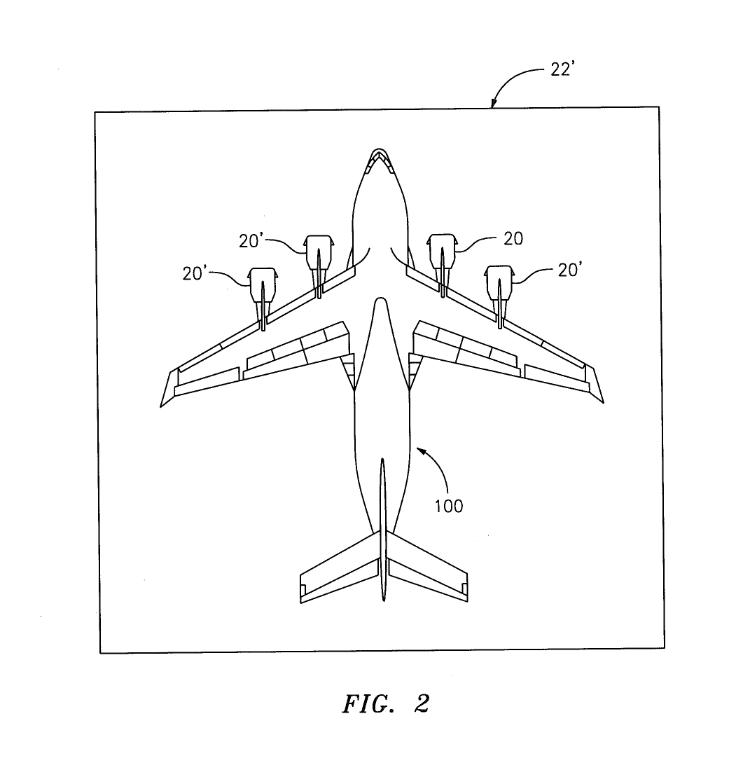

FIG. 1 schematically illustrates a gas turbine engine 20 within an enclosure 22 (illustrated schematically) typical of an industrial gas turbine (IGT). The National Electrical Code (NEC) defines the volume within the enclosure 22 as a hazardous location such as those “where fire or explosion hazards may exist due to flammable gases or vapors, flammable liquids, combustible dust, or ignitable fibers or flyings.” A substantial part of the NEC is devoted to the discussion of hazardous locations because electrical equipment can become a source of ignition in these volatile areas. The volume within the enclosure 22 is defined as Class 1, Division 2 (group D). A Class 1 Hazardous Location is one in which flammable gases or vapors may be present in the air in sufficient quantities to be explosive or ignitable. Division 2—is an abnormal condition when the hazardous material is expected to be confined within closed containers or closed systems and will be present only through accidental rupture, breakage or unusual faulty operation. It should be appreciated that the enclosure 22 as defined herein may encompass other enclosures such as a testing enclosure 22′ large enough to, for example, contain an entire aircraft 100 such that the gas turbine engines 20′ may be tested on-wing (FIG. 2).

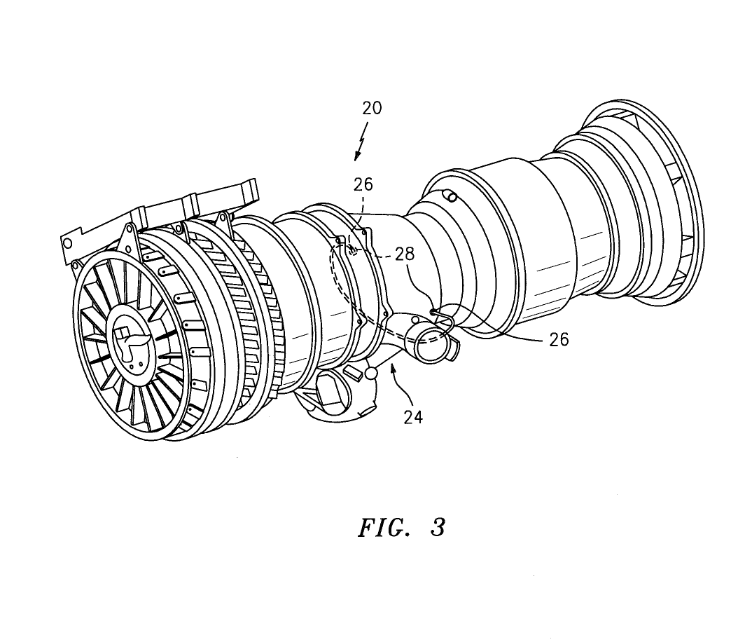

With reference to FIG. 3, the gas turbine engine 20 includes an ignition system 24. The ignition system 24 typically includes two (2) ignitor plugs 26 mounted in the gas turbine engine 20. The ignition system 24 produces approximately seventeen (17) joules of energy at high voltage (potential). Under test conditions, a single ignitor plug 26 is sufficient to operate the engine start sequence such that a port 28 for the other ignitor plug 26 may be utilized for test instrumentation. That is, one (1) of the two (2) ignitor plugs 26 are removed and the empty igniter port 28 may be used to insert an instrument probe.

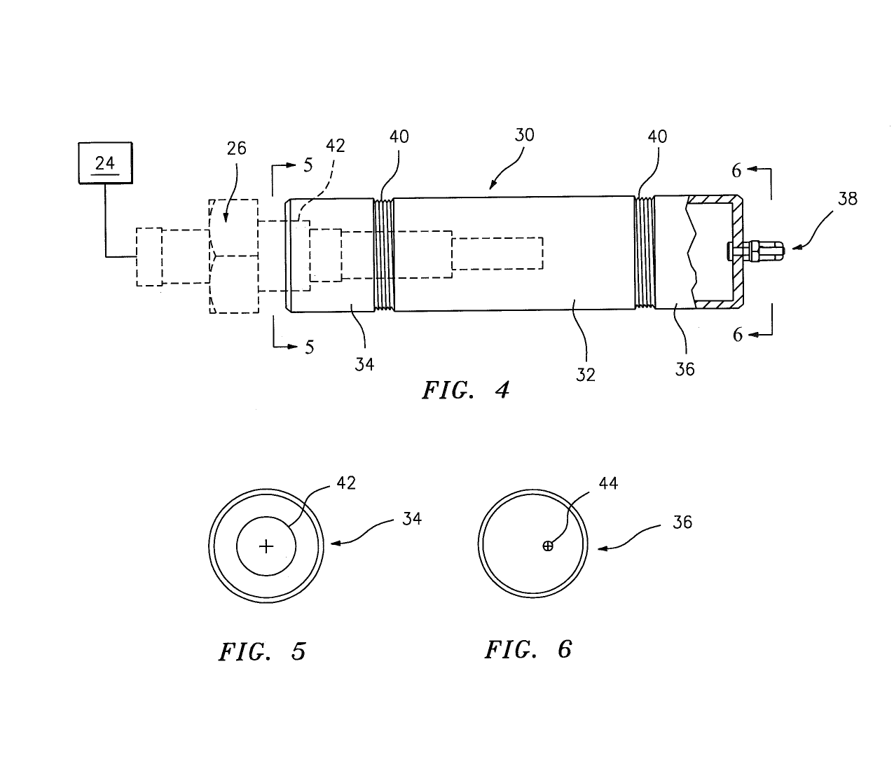

With reference to FIG. 4, the removed ignitor plug 26 is contained and grounded within an Ignitor Plug Isolation Chamber (IPIC) 30 to provide a containment system to isolate the ignitor plug 26 during the engine start sequence and while the engine is running. The ignitor plug 26 is isolated so that the ignition system 24 may be operated as normal during the test procedure. That is, the removed ignitor 26 still sparks but is isolated so the sparks do not effect engine operation.

The IPIC 30 generally includes a cylinder 32, a first end cap 34, a second end cap 36 and a ground connection 38. The cylinder 32 in one disclosed non-limiting embodiment may be manufactured of a six (6) inch (15 cm) standard schedule 40 (ASTM A106 Grade B Carbon Steel) pipe nipple with 1.5 inch (38 mm) NPT (National Pipe Threads) threads 40 on both end sections for receipt of the end caps 34, 36, each of which may be a 1.5 inch (38 mm) cap manufactured of schedule 40 (ASTM A106 Grade B Carbon Steel).

The first end cap 34 includes a threaded aperture 42 (see FIG. 5) to receive the ignitor plug 26 removed for instrumentation of the associated ignitor port 28 (see FIG. 3). The IPIC 30 (see FIG. 4) thereby readily receives various ignition plugs with only a change in the first end cap 34 as the cylinder 32 is longer than typical ignitor plug 26.

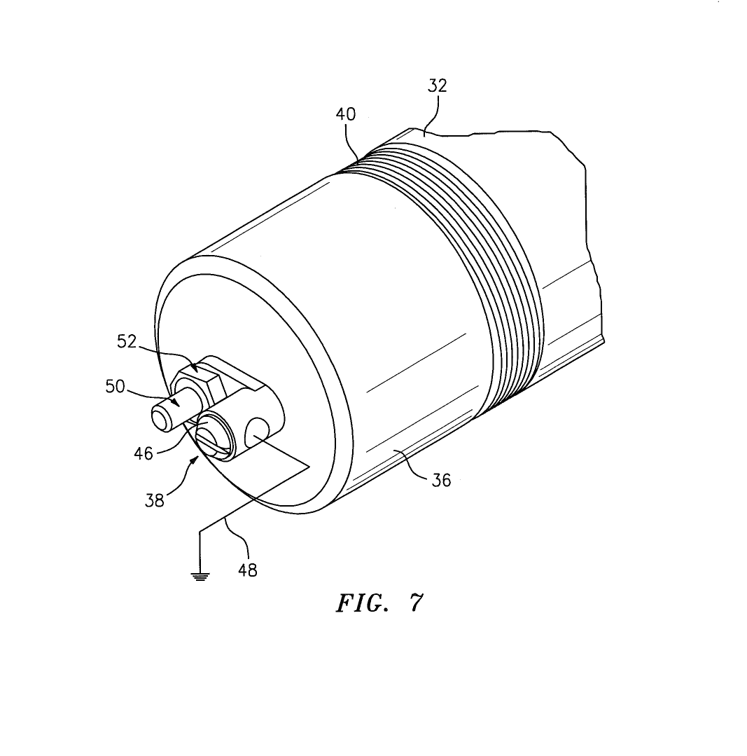

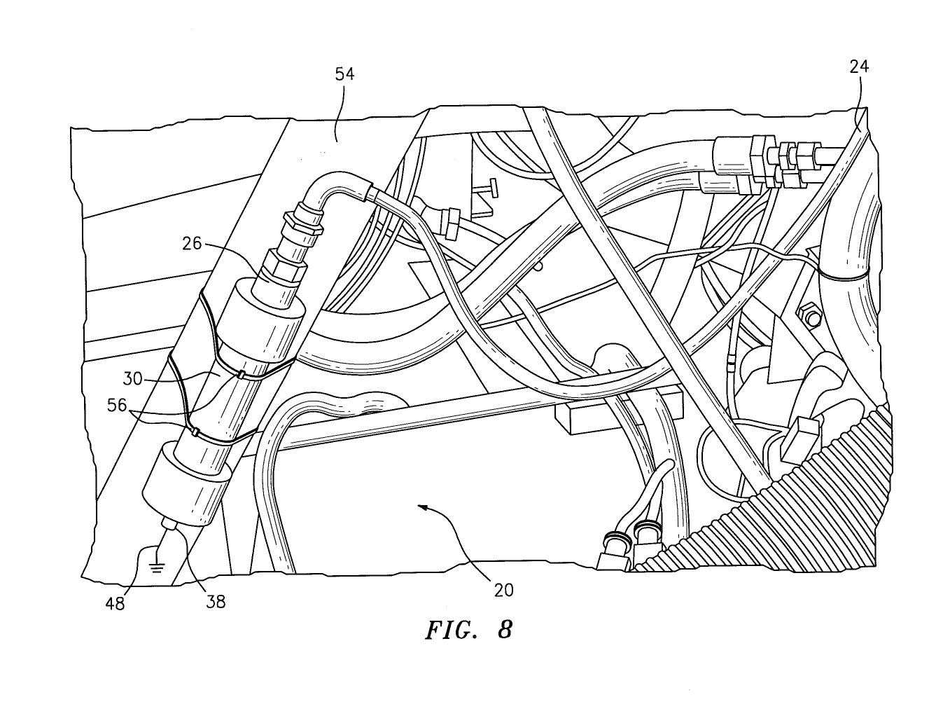

With continued reference to FIG. 4, the second end cap 36 (see FIG. 6) includes an aperture 44 to receive the ground connection 38 (see FIG. 7). The IPIC 30 provides an air sealed and electrically grounded environment for the ignitor plug 26 to discharge an approximate one (1) inch (25 mm) electric arc safely therein. It should be appreciated that other shapes and sizes may alternatively be utilized for the IPIC 30 so long as an ignition end of the ignitor plug 26 is physically spaced from the second end cap 36.

With reference to FIG. 7, the ground connection 38 generally includes a wire hookup 46 for attachment to a grounding cable 48. The wire hookup 46 is attached to the second end cap 36 with a bolt 50 and nut 52 that is threaded into the aperture 44. It should be appreciated that other attachments may alternatively be utilized.

In operation, the removed ignitor plug 26 need only be screwed into the IPIC 30 and the grounding cable 48 connected to the ground connector 38. The IPIC 30 may then be attached to structure 54 with, for example, cable ties 56 (see FIG. 8). The IPIC 30 provides a sealed and grounded environment for electrical function of the ignitor plug 26 to allow instrumentation of the ignition port 28 from which the ignitor plug 26 was removed. This facilitates low cost uncomplicated testing procedures which do not decrease the life of the ignition system 24. The IPIC 30 is a robust design that insures complete isolation from NEC Class 1, Division 2 (Zone 2) environments. The metallic construction of the IPIC 30 is also resistant to the heat of a gas generator at full power-non-metallic versions of conventional ignition-containment devices cannot meet these requirements.

It should be understood that like reference numerals identify corresponding or similar elements throughout the several drawings. It should also be understood that although a particular component arrangement is disclosed in the illustrated embodiment, other arrangements will benefit herefrom.

Although particular step sequences are shown, described, and claimed, it should be understood that steps may be performed in any order, separated or combined unless otherwise indicated and will still benefit from the present disclosure.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims It is therefore to be understood that within the scope of the appended claims, the disclosure may be practiced other than as specifically described. For that reason the appended claims should be studied to determine true scope and content.

What is claimed is:

1. An Ignitor Plug Isolation Chamber (IPIC) comprising:
a cylinder;
a first end cap mountable to said cylinder, said first end cap includes an igniter aperture to receive an ignitor plug;
a second end cap mountable to said cylinder, said second end cap includes a ground aperture; and
a ground connection mounted to said ground aperture.

2. The IPIC as recited in claim 1, wherein said cylinder is approximately six (6) inches (15 cm) long.

3. The IPIC as recited in claim 1, wherein said cylinder is manufactured of a standard schedule 40 (ASTM A106 Grade B Carbon Steel) pipe nipple.

4. The IPIC as recited in claim 1, wherein said first end cap and said second end cap are each 1.5 inch (38 mm) caps manufactured of schedule 40 (ASTM A106 Grade B Carbon Steel).

5. The IPIC as recited in claim 1, wherein said first end cap and said second end cap are threaded to said cylinder.

6. A method of testing a gas turbine engine comprising:
removing an igniter plug from a port in a gas turbine engine;
threading an instrument into the port of the gas turbine engine; and
threading the igniter plug removed from the port of the gas turbine engine into an Ignitor Plug Isolation Chamber (IPIC).

7. The method as recited in claim 6, further comprising:
connecting a grounding cable to the IPIC.

8. The method as recited in claim 6, further comprising:
threading the igniter plug removed from the port of the gas turbine engine into an end cap of the EPIC.

9. The method as recited in claim 6, further comprising:
attaching the IPIC to a structure with cable ties.

10. The method as recited in claim 6, further comprising:
providing an air-tight volume within the IPIC.
